(19) United States
(12) Patent Application Publication
(10) Pub. No.: US 2015/0100719 A1
(43) Pub. Date: Apr. 9, 2015

(54) DATA BACKUP METHOD AND DEVICE THEREOF

(71) Applicant: AutoChips Inc., Hefei City (CN)

(72) Inventors: Jianghong LIN, Hefei City (CN); Jiajie HAO, Hefei City (CN)

(21) Appl. No.: 14/338,344

(22) Filed: Jul. 22, 2014

(30) Foreign Application Priority Data
Oct. 8, 2013 (CN) 201310467719.1

(51) Int. Cl. G06F 11/14; G06F 12/02; G06F 3/06

(52) U.S. Cl. CPC G06F 11/1458; G06F 3/0619; G06F 3/065; G06F 3/0679; G06F 12/0246
USPC 711/103

(57) ABSTRACT

A data backup method and device for a NAND storage unit are provided. The method includes determining whether a portion of data stored in the NAND storage unit is critical data in compliance with a predetermined backup rule, and backing up the critical data if the data is the critical data. Through the provided method and device, the present invention solves the problem of wasting the storage space caused by backing up the data without distinguish the data.

### BACKGROUND

The present invention relates to the field of data storage, and more particularly, to a data backup method and device.

An NAND storage device is a non-volatile storage device, adapted to store a great quantity of data. Due to the large capacity and fast rewrite speed, the NAND storage device has been widely used on vehicle electronic devices and embedded devices, to store operating systems (OSs) data and user data.

However, the inherent characteristic of the hardware of the NAND storage device may cause the bit flip effect or bad block. The bit flip effect occurs when a bit in the NAND storage device changes to 0 from 1 or changes to 1 from 0. The bit flip effect can be caused by drifting effects, program-disturb errors and read-disturb errors. The bit flip effect may cause error occur in the data stored in the NAND storage device. If the stored data is important data and is error, the operation system and application procedure of the vehicle electronic device or embedded device may not be normally operated or can not even be activated.

A conventional method for resolving the aforementioned problem uses other storage mediums, such as a NOR storage device, to replace the NAND storage device. However, compared with the NAND storage device, the cost of other storage mediums will raise the overall cost.

Another conventional method for resolving the aforementioned problem backs up the data stored in the NAND storage device. The current data backup technique includes normal backup and smart backup. The normal backup is to back up all data without distinguishing the data. This technique encounters the problem of wasting storage space. When the storage space of the vehicle electronic device or embedded device is insufficient, extra NAND storage devices will be further required, which raises the cost of the manufacturer. The smart backup is used to back up data to a storage page of a normal NAND storage device using page as unit when the data error exceeds an error correction threshold, and tag the original data as bad data. Although the aforementioned backup technique uses page as unit to perform the backup operation, it still performs the backup without determining whether the data is needed to be backed up. Sometimes the backup method maybe completely unreliable because the run-time error may suddenly jumps to a state that exceeding correction threshold, thus causes it is too late to back up. Hence, this backup technique also has the problem of wasting the storage space and cannot grantee the data integrity.

### SUMMARY

For resolving the aforementioned problems, the present invention provides a data backup method and device.

According to an embodiment of the present invention, a data backup method for a NAND storage unit is provided. The data backup method includes determining whether a portion of data stored in the NAND storage unit is critical data in compliance with a predetermined backup rule; and if the data is the critical data, backing up the critical data.

According to another embodiment of the present invention, a data backup device for a NAND storage unit is provided. The data backup device includes a determining module and a backup module. The determining module is arranged for determining whether a portion of data stored in the NAND storage unit is critical data in compliance with a predetermined backup rule. The backup module is arranged for backing up the critical data if the data is the critical data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows the structure of a data backup device according to a first embodiment of the present invention.

FIG. 2 shows the structure of a data backup device according to a second embodiment of the present invention.

FIG. 3 is a flowchart illustrating the data backup method according to a first embodiment of the present invention.

FIG. 4 is a flowchart illustrating the data backup method according to a second embodiment of the present invention.

FIG. 5 is a flowchart illustrating determining whether the data is the critical data in FIG. 4 according to a first embodiment of the present invention.

FIG. 6 is a flowchart illustrating determining whether the data is the critical data in FIG. 4 according to a second embodiment of the present invention.

FIG. 7 is a flowchart illustrating determining whether the data is the critical data in FIG. 4 according to a third embodiment of the present invention.

FIG. 8 is a flowchart illustrating the data backup method according to a third embodiment of the present invention.

FIG. 9 is a flowchart illustrating the data backup method according to a fourth embodiment of the present invention.

FIG. 10 is a flowchart illustrating the data backup method according to a fifth embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

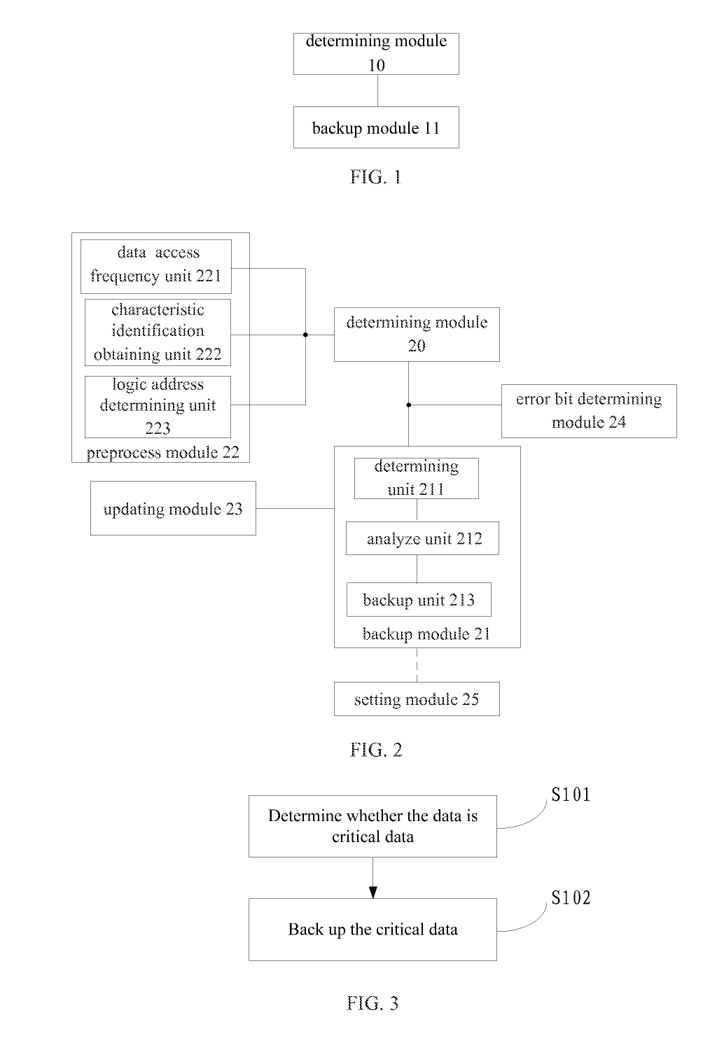

Please refer to FIG. 1, which shows the structure of a data backup device according to a first embodiment of the present invention. As shown in FIG. 1, the device includes a determining module 10 and a backup module 11.

The determining module 10 is arranged for determining whether a portion of data stored in a NAND storage unit is the critical data in compliance with a predetermined backup rule.

The backup module 11 is arranged for backing up the critical data if the data is critical.

Please refer to FIG. 2, which shows the structure of a data backup device according to a second embodiment of the present invention. As shown in FIG. 2, the device includes a determining module 20, a backup module 21, a preprocess module 22, an update module 23 and an error bit determining module 24.

The determining module 20 is coupled to the preprocess module 22, and is arranged for determining whether a portion of data stored in a NAND storage unit is critical data in compliance with a predetermined backup rule. The preprocess module 22 outputs information related to the data, and the determining module 20 determines whether the data is critical data according to information related to the data. For example, the critical data can be an activation guiding procedure, an operating system mirror document data, a system arrangement data or user-defined critical data.

In the various embodiments of the present invention, information related to the data may include a data access frequency, a characteristic identification of the data, or determining whether a logic address corresponding to the data exists in a logic address backup record table. The preprocess module 22 may include an data access frequency unit 221, a characteristic identification obtaining unit 222 and a logic address determining unit 223. The determining module 20 can determine whether the data is critical data in three ways according to the preprocess results (i.e., information related to the data) provided by the preprocess module 22. One skilled in the art can realize that one or multiple preprocess results can be used to determine whether the data is critical data.

More specifically, the data access frequency unit 221 is used to obtain a data access frequency. If the data access frequency is larger than a predetermined value, the determining module 20 determines the data as critical data.

The characteristic identification obtaining unit 222 is used to obtain a corresponding characteristic identification of the data. The determining module 20 determines whether the data is critical data according to the characteristic identification obtained by the characteristic identification obtaining unit 222.

The logic address determining unit 223 is used to determine whether a logic address corresponding to the data exists in a logic address backup record table. If the logic address determining unit 223 determines that the logic address corresponding to the data exists in the logic address backup record table, the determining module 20 determines the data as critical data.

The backup module 21 is coupled to the determining module 20, and is arranged for backing up data when the determining module 20 determines the data as critical data. More specifically, the backup module 21 includes a determining unit 211, an analyze unit 212 and a backup unit 213. The determining unit 211 is arranged for determining whether the critical data is backed up. The analyze unit 212 is arranged for analyzing a logic address where the critical data is stored when the determining unit 211 determines that the critical data is not backed up. The backup unit 213 is arranged for backing up the critical data according to the logic address, and recoding a mapping relationship between the logic address and a physical address corresponding to the critical data. As well known in the art, the logic address and the physical address may be identical if there is no file system existing in the system.

The updating module 23 is coupled to the backup module 21. More specifically, updating module 23 is coupled to the determining unit 211 of the backup module 21, and is arranged for determining whether the critical data is needed to be updated when the determining unit determines that the critical data has been backed up. If the critical data is needed to be updated in run-time, updating and backing up the critical data, and recoding a mapping relationship between a logic address and a physical address corresponding to the updated critical data.

The error bit determining module 24 is coupled to the determining module 20 and the backup module 21, and is arranged for determining whether a number of error bits corresponding to the backup data or the original data of the critical data exceed an error correction warning threshold. When the error bit determining module 24 determines that the number of error bits corresponding to the backup data exceeds the error correction warning threshold, the backup module again backs up the backup data of the original data. When the error bit determining module 24 determines that the number of error bits corresponding to the original data exceed the error correction warning threshold, the backup module backs up the original data.

In another embodiment of the present invention, the data backup device further includes a setting module 25. The setting module 25 is coupled to the backup module 21, and is arranged for determining whether the backup module 21 completes backing up the data when the data backup device is activated again if power failure is occurred during the operation of backing up the data. If the operation of backing up the data has been completed, the setting module 25 sets data needed to be replaced as garbage data.

Please refer to FIG. 3, which is a flowchart illustrating the data backup method according to a first embodiment of the present invention. The method can be used by the data backup device shown in FIG. 1. As shown in FIG. 3, the method includes following steps.

Step S101: Determine whether the data is critical data.

Step S102: Back up the critical data.

In step S101, the data can be categorized into critical data and ordinary data. The critical data is the data capable of affecting the operating system or application procedure, such as the activation guiding procedure, operating system mirror data, system arrangement data, user-defined critical data, etc. The ordinary data is the data that will not affect the system even if it is damaged, such as the data for setting brightness or volume. If the ordinary data is damaged, it can be regenerated by a default value in the system or through operating a corresponding application procedure.

The method performs step S101 so that the determining module 10 determines whether a portion of data stored in the NAND storage unit is the critical data in compliance with the predetermined backup rule. If determining module 10 determines the data as critical data, the method performs step S102 so that the backup module 11 will back up the critical data. The original data and the backup data corresponding to the critical data are stored in different physical address space of the NAND storage device. If the original data is damaged or lost, it can be replaced by the backup data to ensure the operating system or the application procedure being normally operated.

In the data backup method according to the first embodiment of the present invention, the data is backed up when the data is determined as critical data. Through above implementations, the problem of wasting the storage space caused by backing up all data without making a distinction between the data in the related art can be solved.

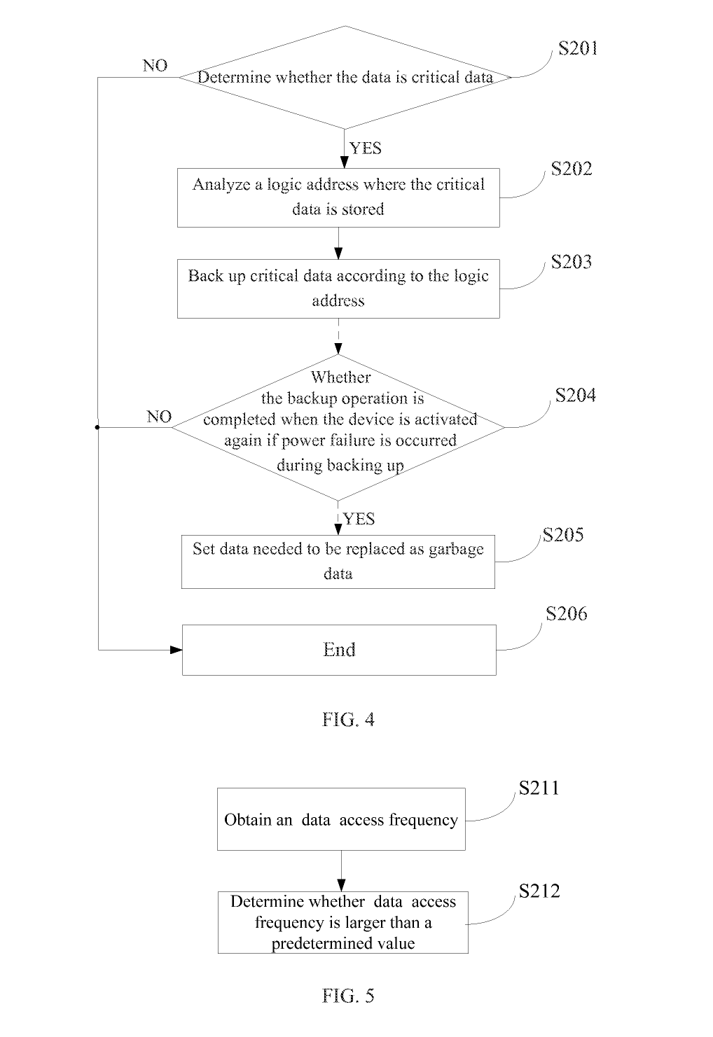

Pleases refer to FIG. 4, which is a flowchart illustrating the data backup method according to a second embodiment of the present invention. The method can be used by the data backup device shown in FIG. 2. Provided that the result is substantially the same, the steps are not required to be executed in the exact order shown in FIG. 4. As shown in FIG. 4, the method includes following steps.

Step S201: Determine whether the data is critical data. If yes, go to step S202; otherwise, go to step S206.

In step S201, the data can be categorized into data dependent on the file system management and data independent on the file system management by the preprocess module 22 shown in FIG. 2. According to the types of the data, three ways can be used to determine whether the data is critical data.

Please refer to FIG. 5, which is a flowchart illustrating determining whether the data is critical data in FIG. 4 according to a first embodiment of the present invention. The operation of determining whether the data is critical data includes following steps.

Step S211: Obtain a data access frequency.

In step S211, the data is independent on the file system arrangement. The data access frequency refers to the frequency of the application procedure performing the read-write operation to the physical address where the data locates. Regarding to the data independent on the file system management, one skilled in the art can realize that the read-write operation performed by the application procedure is through transforming the logic address corresponding to the data into a physical address, and then directly performing the read-write operation to the physical address. The data access frequency unit 221 obtains the data access frequency corresponding to the physical address by counting the times of the application procedure performing the read-write operation to the physical address during a specific period.

Step S212: Determine whether the data access frequency is larger than a predetermined value.

In step S212, the data will be determined as critical data by the determining module 20 if the data access frequency is larger than the predetermined value. The predetermined value is not limited to a specific value and can be set based on actual needs.

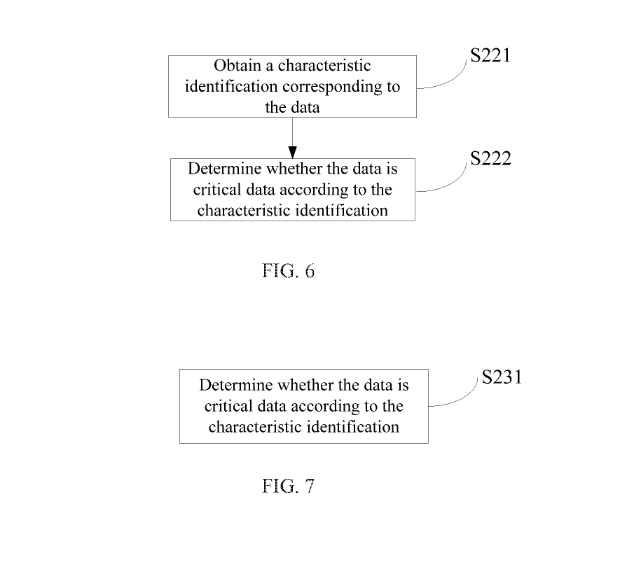

Please refer to FIG. 6, which is a flowchart illustrating determining whether the data is the critical data in FIG. 4 according to a second embodiment of the present invention. As shown in FIG. 6, the operation of determining whether the data is the critical data includes following steps.

Step S221: Obtain a characteristic identification corresponding to the data.

In step S221, the data is dependent on the file system management, e.g., the system data, user data, etc. The characteristic identification can be obtained by the characteristic identification obtaining unit 222 through looking up a document mapping table. The document mapping table is preserved in a storage device such as a dynamic random access storage device or a flash. The document mapping table is used to record document names and characteristic identifications corresponding to the document names. The structure of the document mapping table is shown as follows.

TABLE 1

| Document Name | Characteristic Identification |
|---|---|
| System Data 1 | High |
| User Data 1 | Medium |
| System Data 2 | Low |
| . . . | . . . |

The characteristic identification is used to distinguish important levels of data. For example, in above table 1, “High” represents important data, “Medium” represents minor important data, and “Low” represents ordinary data.

Step S222: Determine whether the data is critical data according to the characteristic identification.

In step S222, when the characteristic identification of the data is determined to be “High,” the determining module 20 will determine the data as critical data. One skilled in the art can realize that the terms “High,” “Medium” and “Low” are merely illustrated for example, and do not used to limit the present invention.

Please refer to FIG. 7, which is a flowchart illustrating determining whether the data is the critical data in FIG. 4 according to a third embodiment of the present invention. As shown in FIG. 7, the operation of determining whether the data is critical data includes following steps.

Step S231: Determine whether a logic address corresponding to the data exists in a logic address backup record table.

In step S231, the data can be categorized into data dependent on the file system management and data independent on the file system management. The logic address backup record table records the logic address of the critical data. When the logic address determining unit 223 determines the logic address of the data is recorded in the logic address backup record table, the data will be determined as critical data.

In the embodiments of the data backup method of FIG. 4, the logic address backup record table will be recorded or updated under the following three situations.

In a first situation, when data is dependent on the file system management and the characteristic identification of data is “High”, the logic address of the data will be recorded in the logic address backup record table.

In a second situation, when the data is dependent on the file system management, the characteristic identification of the data is “High” and the data is updated, the logic address of the document recorded in the logic address backup record table will be updated.

In a third situation, when the data is independent on the document system management, the determining module 20 determines whether the data is critical data according to the data access frequency, and when the data access frequency is larger than a predetermined value, the logic address of the data will be recorded in the logic address backup record table.

If the data is determined as critical data, the operation goes to step S202.

Step S202: Analyze a logic address where the critical data is stored using the analyze unit 212.

In step S202, when the critical data is dependent on the file system management, the step of analyzing a logic address where the critical data is stored is more specifically to look up a corresponding logic address according to the mapping relationship of the file system (e.g., the cluster of the FAT file system corresponds to the logic section). One skilled in the art can realize that the storage location of the data is displayed in the form of catalogue such as: F:\a.txt. The storage location of the directory table of the file system is displayed in the form of cluster. The structure of the directory table of the file system is shown as follows.

TABLE 2

| Document | Initial | | | | |
|---|---|---|---|---|---|
| Name | Cluster | Size | Created Date | Modified Date | Property |
| a.txt | 2 | 10 | 2004.3.22 | 2004.3.22 10:41 | Read-only |
| | | | 10:41 | | |
| c.txt | 66 | 20.7 | 2007.9.22 | 2007.9.22 21:41 | System |
| | | | 21:41 | | |
| . . . | . . . | . . . | . . . | . . . | . . . |

As shown in table 2, according to the directory table of the file system, the initial cluster corresponding to the data a.txt can be obtained as 2, and the logic address of the data can be obtained according to the corresponding relationship between the cluster and logic section.

When the critical data is independent on the file system management, the step of analyzing a logic address where the critical data is stored is more specifically to directly obtain the logic address corresponding to the critical data.

Step S203: Back up critical data according to the logic address using the backup unit 213.

In step S203, the logic address is transformed into two different physical addresses by the flash translation layer (FTL), and then the contents of the critical data are written into the two different physical addresses by the flash media driver (FMD), to implement the backup of the critical data.

Step S204: if power failure is occurred during backing up the data, the setting module 25 determines whether the backup operation is completed when the device is activated again. If yes, go to step S205; otherwise, go to step S206.

Under the circumstances that power failure is occurred during backing up data, if write operation of new data is not completed and the data needed to be replaced is marked as garbage data in advance, the system may be invalid when being activated again. To prevent from the above problems, a preferred embodiment of the present invention determines whether the backup operation has been completed when the device is activated again after the power failure has been occurred (step 204). If backup operation has been completed, step S205 will be performed.

Step S205: Set data needed to be replaced as garbage data.

In step S205, the data needed to be replaced will be set as garbage data by the setting module 25 if the backup operation is detected to have been completed.

Step S206: End.

Through the aforementioned implementations, the data backup method according to the second embodiment of the present invention determines whether the data is critical data according to the characteristic of the data, and backs up the data according to the logic address of the data when the data is determined as critical data. Hence, the problem of wasting storage space caused by backing up data without distinguish data in the related art can be solved.

Further, if power failure is occurred during backing up data, the data backup method according to the second embodiment of the present invention will set the data needed to be replaced as garbage data only when the data backup operation is completed. Hence, even if power failure is occurred during backing up data, data error can be avoided to ensure the system valid.

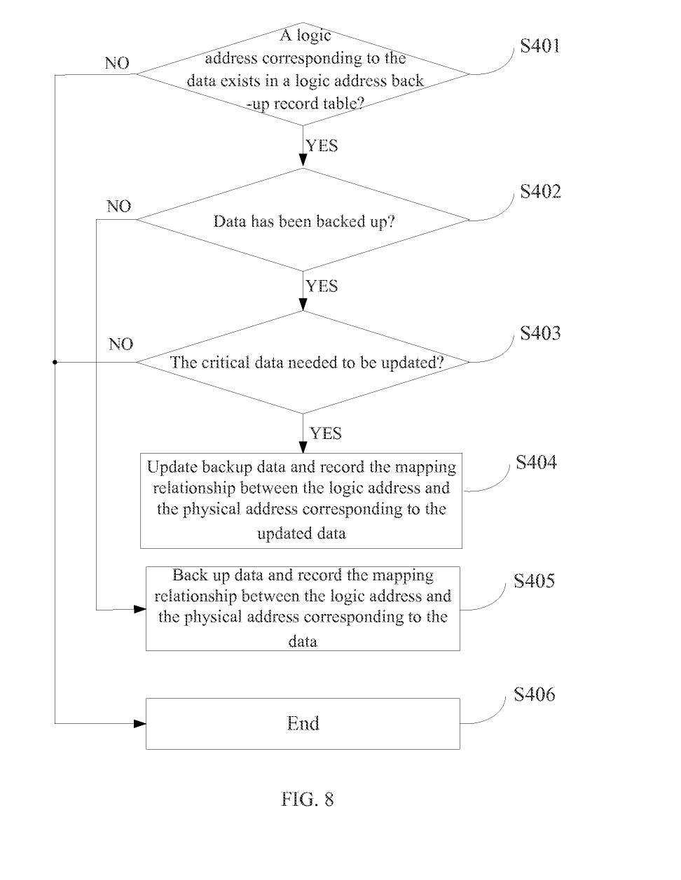

Please refer to FIG. 8, which is a flowchart illustrating the data backup method according to a third embodiment of the present invention. The data backup method can be applied to a NAND storage device. Provided that the result is substantially the same, the steps are not required to be executed in the exact order shown in FIG. 8. As shown in FIG. 8, the method includes following steps.

Step S401: Determine whether a logic address corresponding to the data exists in a logic address backup record table. If yes, go to step S402; otherwise, go to Step S406. In step S401, when the logic address determining unit 223 determines the logic address corresponding to the data exists in a logic address backup record table, the data will be determined as critical data. The logic address backup record table records the logic address corresponding to the critical data.

Step S402: Determine whether the data has been backed up using the determining unit 211. If yes, go to step S403; otherwise, go to step S405. When data is determined to be critical data, step S402 determines whether the critical date is backed up. More specifically, backup of critical data can be determined through looking up a backup record table. The backup record table may include a logic address item and a backup record item. After critical data is identified, write the logic address corresponding to the critical data into the backup record table, and tag the backup record item corresponding to the logic address as “not backed up”. When the critical data is backed up, update the backup record item of the logic address corresponding to the critical data as “backed up”.

Step S403: Determine whether the critical data is needed to be updated using the updating module 23. If yes, go to step S404; otherwise, go to step S406. After the step S402 determines the critical data has been backed up, in step S403, determining whether the backed up critical data is needed to be updated. More specifically, if the critical data is dependent on the file system management, whether the critical data is needed to be updated can be determined according to the size or the modified date of the data.

Step S404: Update backup data and record the mapping relationship between the logic address and the physical address corresponding to the updated data using the updating module 23. After step S403 determines that the critical data needs to be updated, step S404 updates critical data and the backup data corresponding to the critical data in the NAND storage device, and records the original data of the updated critical data and the mapping relationship between the physical address of the backup data of the updated critical data and the logic address of the updated critical data.

For example, if the critical data is dependent on the file system management, when data needs to be updated, the data backup device looks up the cluster number corresponding to the data in the directory table according to the directory of the data, and obtains the logic address corresponding to the data according to the cluster number and the corresponding relationship of the logic section. Then the flash transform layer transforms the logic address into the physical address. Next, the flash medium driver performs the update operation to the original data and the backup data in the NAND storage device according to the physical address. After the data is updated, the data backup device records the updated original data and the mapping relationship between the physical address of the updated backup data in the NAND storage device and the logic address of the updated data in the file system.

Step S405: Back up data and record the mapping relationship between the logic address and the physical address corresponding to the data using the backup unit 213.

When step S402 determines that the critical data has not been backed up, in step S405, the write operation will be performed to the NAND storage device to write the original data and the backup data of the critical data at different physical addresses. After the write operation is completed, the data backup device records the mapping relationships between the physical address of the original data/the backup data and the logic address of the critical data.

Step S406: End.

As illustrated in the above implementations, the data backup method according to the fourth embodiment of the present invention determines whether the data is critical data by determining that whether the logic address corresponding to the data exists in the logic address backup record table. If the critical data is not backed up, then the backup operation is performed. If the critical data has been backed up and needs to be updated, then the update operation is performed. Hence, the problem of performing the backup operation without determining whether the data needs to be backed up which results in wasting the storage space can be solved.

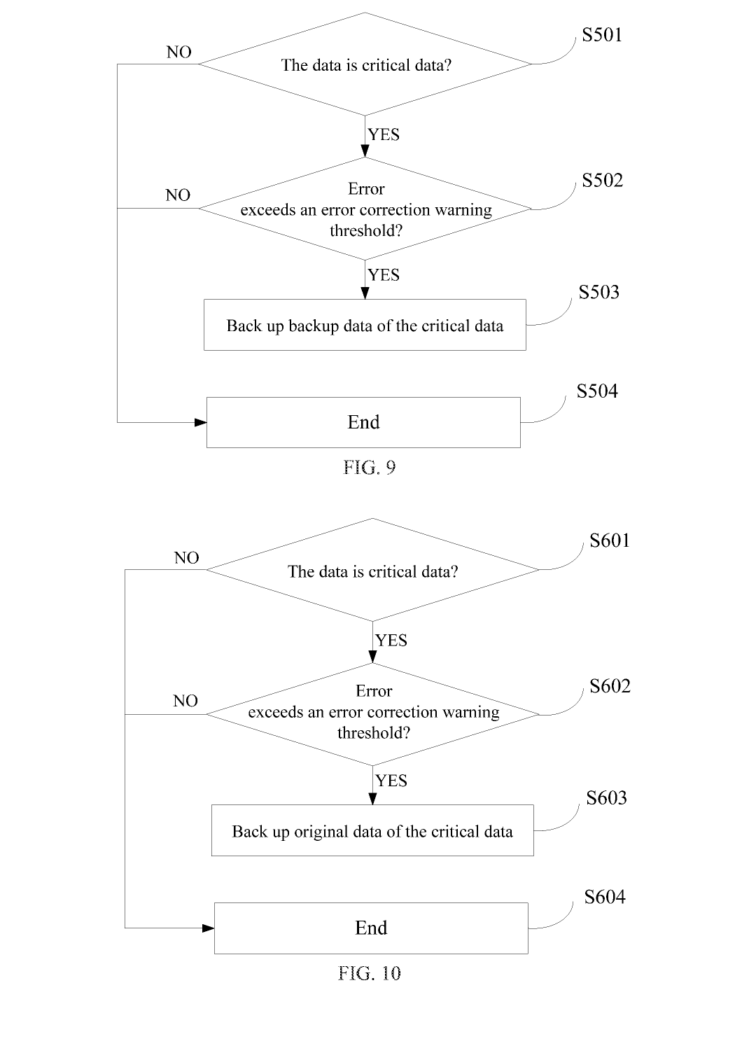

Please refer to FIG. 9, which is a flowchart illustrating the data backup method according to a fourth embodiment of the present invention. The data backup method can be applied to a NAND storage device. Provided that the result is substantially the same, the steps are not required to be executed in the exact order shown in FIG. 9. As shown in FIG. 9, the method includes following steps.

Step S501: Determine whether the data is critical data. If yes, go to step S502; otherwise, go to step S504.

In this embodiment, step S501 is similar to step S201 in FIG. 4, and the descriptions of step S501 will be omitted for brevity.

Step S502: Determine whether error corresponding to backup data of the critical data exceeds an error correction warning threshold using the error bit determining module 24. If yes, go to step S503; otherwise, go the step S504.

In step S502, the error correction warning threshold is an error correcting code (ECC) error correction warning threshold. The ECC error correction warning threshold is selected according to the size of the spare area in the NAND storage device. Because the ECC technique requires occupying the spare area in the NAND storage device to store the redundant data, a larger spare area is needed for larger ECC error correction warning threshold. For example, if the error correction warning threshold is 24 bit per thousand byte, 42 byte redundant data is needed, and if the error correction warning threshold is 40 bit per thousand byte, 70 byte redundant data is needed. The item “24 bit per thousand byte” means that when the ECC error correction is performed, number of error bit is allowed to be under or equal to 24 among 1000 bytes data. If the number of error bit exceeds 24, data stored in the NAND storage device can not be correctly read. Similarly, the item “40 bit per thousand byte” means that when the ECC error correction is performed, the number of error bit is allowed to be under or equal to 40 among 1000 bytes data.

More specifically, determining whether error corresponding to backup data of the critical data exceeds an error correction warning threshold of 24 bit per thousand byte can be realized as determining whether a number of error bit of the backup data exceeds 24 among each 1000 byte. If the number of error bit exceeds 24, it means the backup data is damaged and can not be correctly read. The above illustration is merely an example, and does not limit the present invention. One skilled in the art can readily understand that the error correction warning threshold can be designed based on actual needs.

Step S503: Back up backup data of the critical data using the backup module 21.

After step S502 determines that backup data of the critical data is damaged, step S503 copies the original data stored in the NAND storage device which corresponds to the critical data to obtain the new backup data, and records the mapping relationship between the physical address of the new backup data and the logic address of the critical data.

Step S504: End.

As illustrated in the above implementations of the data backup method of the fourth embodiment of the present invention, when the backup data of the critical data is detected to be damaged during reading the data, backing up the critical data again according to the original data, thus raising the stability of the critical data, and thereby insuring the system operates normally.

Please refer to FIG. 10, which is a flowchart illustrating the data backup method according to a fifth embodiment of the present invention. The data backup method can be applied to a NAND storage device. Provided that the result is substantially the same, the steps are not required to be executed in the exact order shown in FIG. 10. As shown in FIG. 10, the method includes following steps.

Step S601: Determine whether the data is critical data. If yes, go to step S602; otherwise, go to Step S604.

In this embodiment, step S601 is similar to step S201 in FIG. 4, and the descriptions of step S601 will be omitted for brevity.

Step S602: Determine whether error corresponding to backup data of the critical data exceeds an error correction warning threshold using the error bit determining module 24. If yes, go to step S603; otherwise, go the step S604. In steps S602, during performing the reading operation to the original data of the critical data, whether the error of the original data exceeds the error correction warning threshold is determined. If the error of the original data exceeds the error correction warning threshold, it means the original data is damaged and can not be correctly read.

Step S603: Back up original data of the critical data using the backup module 21. After step S602 determines that the original data of the critical data is damaged, step S603 copies the backup data of the critical data stored in the NAND storage device to obtain a new original data, and records the mapping relationship between the physical address of the new backup data and the logic address of the critical data.

Step S604: End.

Through the aforementioned implementations, in the data backup method according to the fifth embodiment of the present invention, when determining the original data of the critical data is damaged during reading the data, the critical data will be backed up again according to the backup data, thus improving the stability of the critical data to insure the system can be normally operated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data backup method for a NAND storage unit, the method comprising:
determining whether a portion of data stored in the NAND storage unit is critical data in compliance with a predetermined backup rule; and
if the data is the critical data, backing up the critical data.

2. The data backup method of claim 1, further comprising:
analyzing a logic address where the critical data is stored; and
backing up the critical data according to the logic address.

3. The data backup method of claim 1, wherein the step of determining whether the data is the critical data further comprises:
obtaining an data access frequency, and determining whether the data access frequency is larger than a predetermined value; and
if the data access frequency is larger than the predetermined value, determining the data as the critical data.

4. The data backup method of claim 1, wherein the step of determining whether the data is the critical data further comprises:
obtaining a characteristic identification corresponding to the data, and determining whether the data is the critical data according to the characteristic identification.

5. The data backup method of claim 1, wherein the step of determining whether the data is the critical data further comprises:
determining whether a logic address corresponding to the data exists in a logic address backup record table; and
if the logic address corresponding to the data exists in the logic address backup record table, determining the data as the critical data;
wherein the logic address backup record table records the logic address corresponding to the critical data.

6. The data backup method of claim 1, further comprising:
determining whether the critical data has been backed up; and
if the critical data has not been backed up, backing up the critical data.

7. The data backup method of claim 6, further comprising:
if the critical data is backed up, determining whether the critical data needs to be updated; and
if the critical data needs to be updated, updating and backing up the critical data.

8. The data backup method of claim 1, further comprising:
determining whether a number of error bits corresponding to backup data of the critical data exceeds an error correction warning threshold; and
if the number of error bit corresponding to the backup data of the critical data exceeds the error correction warning threshold, backing up the backup data.

9. The data backup method of claim 1, wherein the critical data is an activation guiding procedure, an operating system mirror data, a system arrangement data or user-defined critical data.

10. The data backup method of claim 1, wherein if power failure is occurred during updating and backing up the data, determining whether the operation of updating and backing up has been completed when a device applies the method is re-activated; if the operation has been completed, setting original data as invalid data; if the operation has not been completed, using the original data to complete activating or system arrangement.

11. A data backup device for a NAND storage unit, comprising:
a determining module, arranged for determining whether a portion of data stored in the NAND storage unit is critical data in compliance with a predetermined backup rule; and
a backup module, arranged for backing up the critical data if the data is the critical data.

12. The data backup device of claim 11, wherein the backup module further comprises:
a determining unit, arranged for determining whether the critical data is backed up;
an analyze unit, arranged for analyzing a logic address where the critical data is stored when the determining unit determines that the critical data is not backed up; and
a backup unit, arranged for backing up the critical data according to the logic address.

13. The data backup device of claim 12, further comprising:
an updating module, arranged for determining whether the critical data needs to be updated when the determining unit determines that the critical data is backed up, wherein if the critical data needs to be updated, updating and backing up the critical data.

14. The data backup device of claim 11, further comprising:
a preprocess module, coupled to the determining module and arranged for outputting information related to the data, wherein the determining module determines whether the data is the critical data according to the information related to the data.

15. The data backup device of claim 14, wherein the preprocess module comprises:
an data access frequency unit, arranged for obtaining an data access frequency, wherein when the data access frequency is larger than a predetermined value, the determining module determines the data as the critical data.

16. The data backup device of claim 14, wherein the preprocess module comprises:
a characteristic identification obtaining unit, arranged for obtaining a characteristic identification corresponding to the data, wherein the determining module is used for determining whether the data is the critical data according to the characteristic identification obtained by the characteristic identification obtaining unit.

17. The data backup device of claim 14, wherein the preprocess module comprises:
a logic address determining unit, arranged for determining whether the logic address corresponding to the data exists in a logic address backup record table, wherein when the logic address corresponding to the data exists in the logic address backup record table, the determining module determined the data as the critical data.

18. The data backup device of claim 11, further comprising:
an error bit determining module, arranged for determining whether a number of error bits corresponding to backup data or original data of the critical data exceeds an error correction warning threshold;
wherein when the error bit determining module determines that the number of error bits corresponding to the backup data exceeds the error correction warning threshold, the backup module backs up the backup data of the original data; when the error bit determining module determines that the number of error bits corresponding to the original data exceeds the error correction warning threshold, the backup module backs up the original data.

19. The data backup device of claim 11, wherein the critical data is an activation guiding procedure, an operating system mirror data, a system arrangement data or user-defined critical data.

20. The data backup device of claim 11, further comprising:
a setting module, arranged for determining whether the operation of backing up the data is completed if power failure is occurred during backing up the data when the data backup device is activated again, wherein if the operation of backing up the data is completed, the setting module sets data needed to be replaced as garbage data.
